(19) United States
(12) Patent Application Publication
(10) Pub. No.: US 2018/0082456 A1
(43) Pub. Date: Mar. 22, 2018

(54) IMAGE VIEWPOINT TRANSFORMATION APPARATUS AND METHOD

(71) Applicant: Fujitsu Limited, Kawasaki-shi (JP)

(72) Inventors: Wei LIU, Beijing (CN); Wei FAN, Beijing (CN); Jun SUN, Beijing (CN)

(73) Assignee: Fujitsu Limited, Kawasaki-shi (JP)

(21) Appl. No.: 15/697,823

(22) Filed: Sep. 7, 2017

(30) Foreign Application Priority Data
Sep. 18, 2016 (CN) 201610829031.7

(51) Int. Cl. G06T 11/60; G06K 9/46; G06K 9/62; G06T 11/00; G06K 9/00

(52) U.S. Cl. CPC G06T 11/60; G06K 9/4604; G06K 9/00463; G06T 11/001; G06K 9/6267

(57) ABSTRACT

Embodiments provide an image viewpoint transformation apparatus and method. The method includes: extracting multiple straight lines based on a gray scale map of a document image; performing classification for the multiple straight lines according to a horizontal direction and a vertical direction; extracting multiple text lines based on a binary map of the document image; performing classification for the multiple text lines according to a horizontal direction and a vertical direction; selecting two vertical lines and two horizontal lines from the extracted and classified straight lines and text lines; calculating a transformation matrix based on a rectangle formed by the selected two vertical lines and two horizontal lines; and transforming the document image by using the transformation matrix to obtain a viewpoint transformed image. Hence, even if a captured document image is incomplete, a perspective transformation matrix may be accurately obtained, thereby better performing image viewpoint transformation.

### CROSS-REFERENCE TO RELATED APPLICATIONS

This application claims the benefit of Chinese Application No. 201610829031.7, filed Sep. 18, 2016, in the Chinese Intellectual Property Office, the disclosure of which is incorporated herein by reference.

### BACKGROUND

### 1. Field

Embodiments of this disclosure relate to the field of graphic image processing, and in particular to an image viewpoint transformation apparatus and method.

### 2. Description of the Related Art

In daily lives, people often use an electronic device (such as a mobile phone) to capture an image of a document (or may be referred to as a document image). Perspective transformation often occurs in the captured image due to capturing angles, etc. Currently, there appear some viewpoint transformation methods, in which a perspective transformation matrix (an H matrix) is obtained by using document boundaries, etc., and then the document image is transformed based on the H matrix to obtain a viewpoint transformed image.

However, a captured image of a document is incomplete sometimes, that is, only a part of the document is shot.

FIG. 1 is a schematic diagram of an example of an original document image captured by using a mobile phone. As shown in FIG. 1, some contents in the right column are not captured. The existing viewpoint transformation methods are unable to accurately obtain a perspective transformation matrix (an H matrix), which results in the inability to perform image viewpoint transformation better.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Additional aspects and/or advantages will be set forth in part in the description which follows and, in part, will be apparent from the description, or may be learned by practice of the embodiments.

Embodiments of this disclosure provide an image viewpoint transformation apparatus and method, in which even if a captured document image is incomplete, a perspective transformation matrix may be accurately obtained, thereby better performing image viewpoint transformation.

According to a first aspect of the embodiments of this disclosure, there is provided an image viewpoint transformation apparatus, including:

a straight line extracting unit or extractor configured to extract multiple straight lines based on a gray scale map of a document image;

a straight line classifying unit or classifier configured to perform classification for the multiple straight lines according to a horizontal direction and a vertical direction;

a text line extracting unit or extractor configured to extract multiple text lines based on a binary map of the document image;

a text line classifying unit or classifier configured to perform classification for the multiple text lines according to a horizontal direction and a vertical direction;

a line selecting unit or selector configured to select two vertical lines and two horizontal lines from the extracted and classified straight lines and text lines;

a matrix calculating unit or calculator configured to calculate a transformation matrix based on a rectangle formed by the selected two vertical lines and two horizontal lines; and

an image transforming unit or transformer configured to transform the document image by using the transformation matrix to obtain a viewpoint transformed image.

According to a second aspect of the embodiments of this disclosure, there is provided an image viewpoint transformation method, including:

extracting multiple straight lines based on a gray scale map of a document image;

performing classification for the multiple straight lines according to a horizontal direction and a vertical direction;

extracting multiple text lines based on a binary map of the document image;

performing classification for the multiple text lines according to a horizontal direction and a vertical direction;

selecting two vertical lines and two horizontal lines from the extracted and classified straight lines and text lines;

calculating a transformation matrix based on a rectangle formed by the selected two vertical lines and two horizontal lines; and

transforming the document image by using the transformation matrix to obtain a viewpoint transformed image.

According to a third aspect of the embodiments of this disclosure, there is provided electronic equipment, including the image viewpoint transformation apparatus described above.

An advantage of the embodiments of this disclosure exists in that multiple straight lines are extracted based on a gray scale map of a document image, and multiple text lines are extracted based on a binary map of the document image; two vertical lines and two horizontal lines are selected from the extracted and classified straight lines and text lines; and a transformation matrix is calculated based on a rectangle formed by the selected two vertical lines and two horizontal lines. Hence, even if a captured document image is incomplete, a perspective transformation matrix may be accurately obtained, thereby better performing image viewpoint transformation.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, blocks, steps or components but does not preclude the presence or addition of one or more other features, integers, blocks, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of an example of an original document image captured by using a mobile phone;

FIG. 2 is a flowchart of the image viewpoint transformation method of Embodiment 1 of this disclosure;

FIG. 3 is a schematic diagram of extracting straight lines of Embodiment 1 of this disclosure;

FIG. 4 is a schematic diagram of detected straight lines of Embodiment 1 of this disclosure;

FIG. 5 is a schematic diagram of extracting text lines of Embodiment 1 of this disclosure;

FIG. 6 is a schematic diagram of detected text lines of Embodiment 1 of this disclosure;

FIG. 7 is a schematic diagram of a document image including multiple zones of Embodiment 1 of this disclosure;

FIG. 8 is a schematic diagram of a source rectangle of Embodiment 1 of this disclosure;

FIG. 9 is a schematic diagram of calculating a transformation matrix of Embodiment 1 of this disclosure;

FIG. 10 is a schematic diagram of a destination rectangle of Embodiment 1 of this disclosure;

FIG. 11 is a schematic diagram of performing viewpoint transformation of Embodiment 1 of this disclosure;

FIG. 12 is a schematic diagram of an example of the viewpoint transformed document image of Embodiment 1 of this disclosure;

FIG. 13 is a schematic diagram of the image viewpoint transformation apparatus of Embodiment 2 of this disclosure;

FIG. 14 is a schematic diagram of a straight line extracting unit of Embodiment 2 of this disclosure;

FIG. 15 is a schematic diagram of a text line extracting unit of Embodiment 2 of this disclosure;

FIG. 16 is a schematic diagram of a matrix calculating unit of Embodiment 2 of this disclosure;

FIG. 17 is a schematic diagram of an image transforming unit of Embodiment 2 of this disclosure; and

FIG. 18 is a schematic diagram of the electronic equipment of Embodiment 3 of this disclosure.

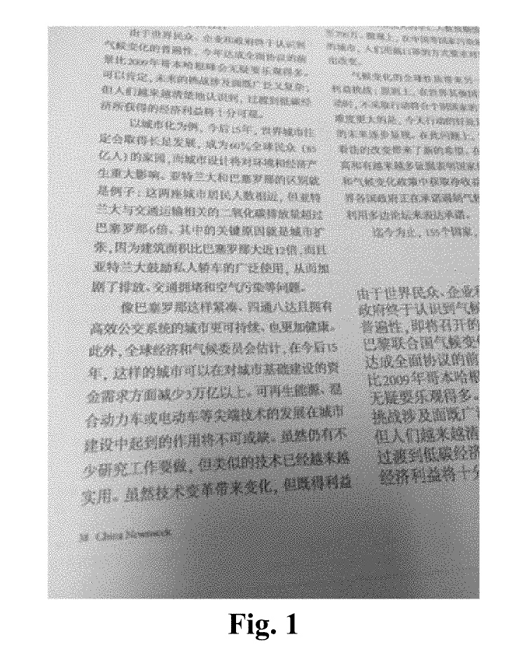

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

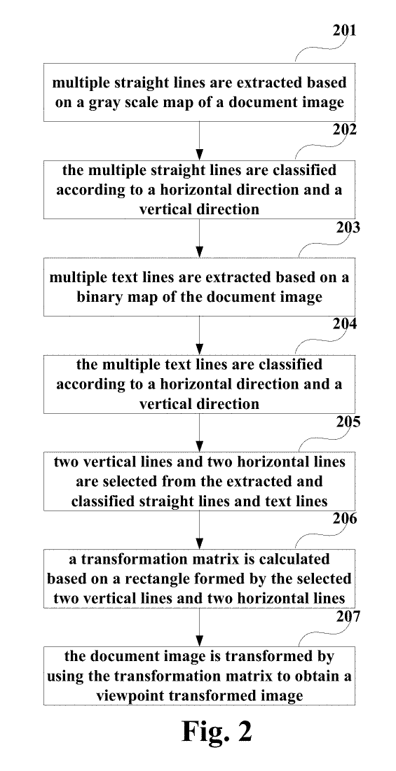

The embodiment of this disclosure provides an image viewpoint transformation method. FIG. 2 is a flowchart of the image viewpoint transformation method of the embodiment of this disclosure. As shown in FIG. 2, the image viewpoint transformation method includes:

Block 201: multiple straight are extracted lines based on a gray scale map of a document image;

Block 202: the multiple straight lines are classified according to a horizontal direction and a vertical direction;

Block 203: multiple text lines are extracted based on a binary map of the document image;

Block 204: the multiple text lines are classified according to a horizontal direction and a vertical direction;

Block 205: two vertical lines and two horizontal lines are selected from the extracted and classified straight lines and text lines;

Block 206: a transformation matrix is calculated based on a rectangle formed by the selected two vertical lines and two horizontal lines; and

Block 207: the document image is transformed by using the transformation matrix to obtain a viewpoint transformed image.

In this embodiment, multiple straight lines are extracted and classified in blocks 201 and 202, so as to obtain table lines, segmentation lines, and image edge contour straight lines, etc., contained in the document image; and multiple text lines are extracted and classified in blocks 203 and 204, so as to obtain the horizontal text line and the vertical text lines including initial characters (or, final characters, for example).

It should be appreciated that the extraction of the straight lines and the text lines may be performed independently, such as being performed in parallel, or being performed sequentially (the straight lines are extracted first, and then the text lines are extracted, or the text lines are extracted first, and then the straight lines are extracted), or being performed crosswise, and this disclosure is not limited thereto.

In this embodiment, two vertical lines and two horizontal lines may be selected from a set of the extracted straight lines and text lines, and then the transformation matrix is calculated based on the rectangle formed by the selected two vertical lines and two horizontal lines. Hence, even if a captured document image is incomplete, a perspective transformation matrix may be accurately obtained, thereby better performing image viewpoint transformation.

The blocks shall be described below in detail.

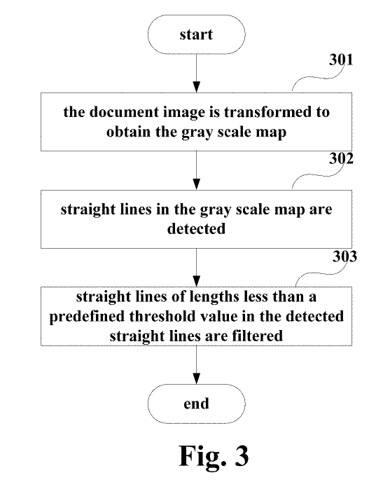

FIG. 3 is a schematic diagram of extracting straight lines of the embodiment of this disclosure. As shown in FIG. 3, the extracting multiple straight lines based on the gray scale map of the document image in the block 201 may include:

Block 301: the document image is transformed to obtain the gray scale map;

Block 302: straight lines are detected in the gray scale map; and

Block 303: straight lines of lengths less than a predefined threshold value are filtered in the detected straight lines.

In particular, gradation processing may be performed first on an original document image, and then candidate straight lines are detected by using various line detection methods (such as a line segmentation detection method, and a Hough line detection method, etc.); and some candidate straight lines may be filtered by using various conditions (such as a length of a line needing to be greater than a threshold, etc.).

In the block 202, the extracted and filtered straight lines may be stored after being classified into horizontal straight lines and vertical straight lines. The classification may be performed by using various conditions (such as that an inclination angle of a straight line needs to be less than a threshold, and/or, angle between a straight line and a text line needs to be less than a threshold, etc.), so as to filter some candidate straight lines.

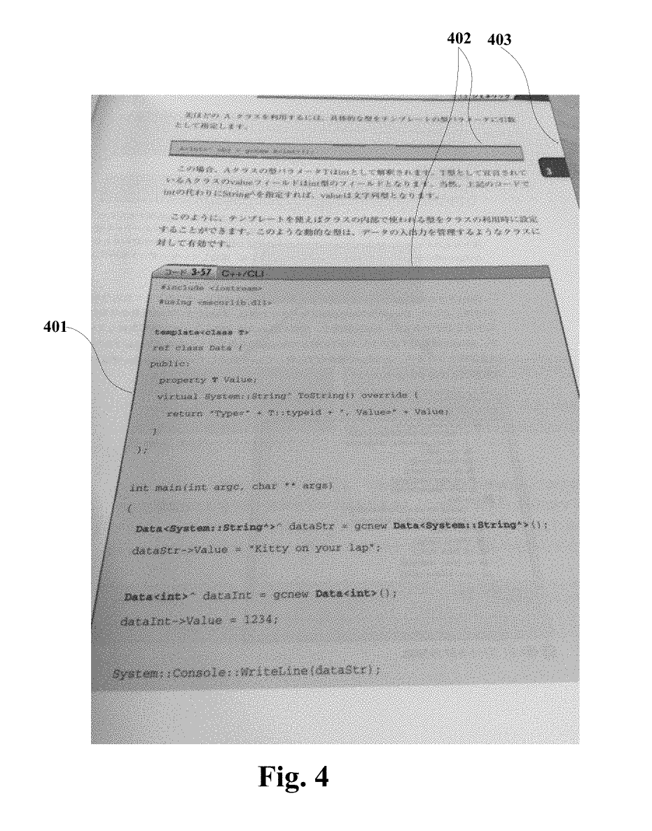

FIG. 4 is a schematic diagram of detected straight lines of the embodiment of this disclosure. As shown in FIG. 4, straight lines in the vertical direction (such as a table line 401, etc.) and straight lines in the horizontal direction (such as a segmentation line 402, and an image edge contour straight line 403, etc.) in the document image may be detected,

It should be appreciated that how to extract straight lines in the document image is only illustrated above. However, this disclosure is not limited thereto; for example, any method for extracting straight line available in the relevant art may be used. Furthermore, this disclosure is not limited to the filtering conditions, and a particular filtering condition may be determined according to an actual situation.

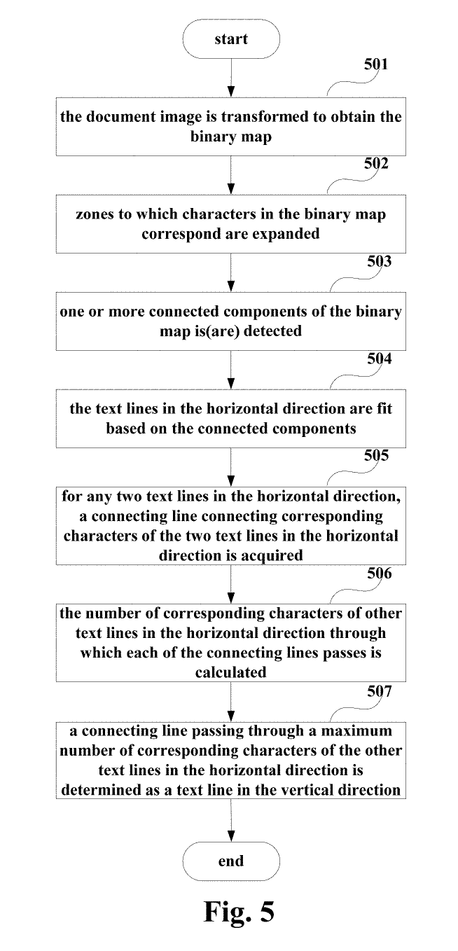

FIG. 5 is a schematic diagram of extracting text lines of the embodiment of this disclosure. As shown in FIG. 5, the extracting multiple text lines based on a binary map of the document image in the block 203 may include:

Block 501: the document image is transformed to obtain the binary map;

Block 502: zones to which characters in the binary map correspond are expanded;

Block 503: one or more connected components (CCs) of the binary map is (are) detected; and

Block 504: the text lines in the horizontal direction are fit based on the connected components.

For example, as for how to perform binary transformation and how to perform connected components marking, any method available in the relevant art may be used, However, this disclosure is not limited thereto. A plurality of text lines in the horizontal direction may be fitted based on the method of connected components.

As shown in FIG. 5, the extracting multiple text lines based on a binary map of the document image may further include:

Block 505: for any two text lines in the horizontal direction, a connecting line connecting corresponding characters (such as initial characters or final characters) of the two text lines in the horizontal direction is acquired;

Block 506: the number of corresponding characters (such as initial characters or final characters) of other text lines in the horizontal direction through which each of the connecting lines passes is calculated; and

Block 507: a connecting line passing through a maximum number of corresponding characters (such as initial characters or final characters) of the other text lines in the horizontal direction is determined as a text line in the vertical direction.

In this embodiment, above blocks 505-507 may be respectively applied to the initial characters and/or final characters (and other characters may be included), so as to obtain the multiple text lines in the vertical direction.

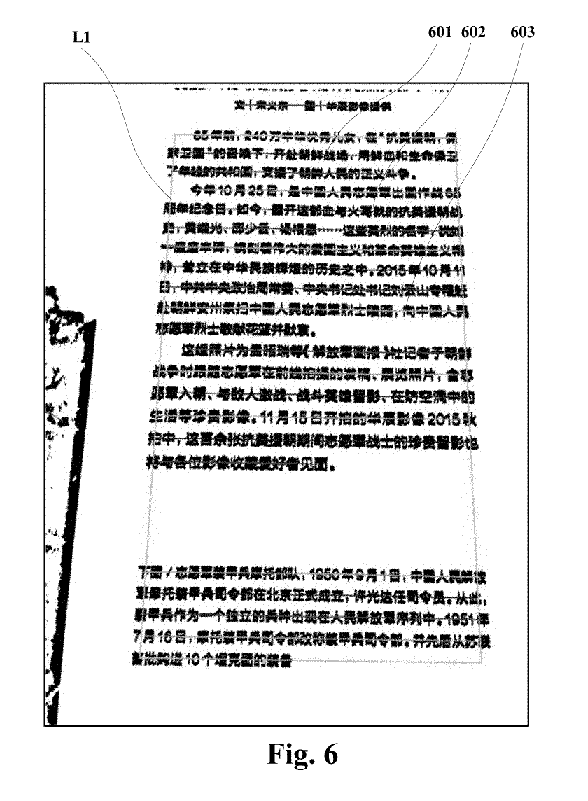

FIG. 6 is a schematic diagram of the detected text lines of the embodiment of this disclosure. As shown in FIG. 6, multiple text lines in the horizontal direction may be fitted based on the connected components. Following description shall be given by taking horizontal text lines 601, 602 and 603 in FIG. 6 as examples.

For example, after multiple horizontal text lines containing the horizontal text lines 601, 602 and 603 are fitted, for the horizontal text lines 601 and 602, a connecting line (hereinafter referred to as L1) connecting initial characters of the horizontal text lines 601 and 602 may be acquired, and the number of initial characters of L1 passing through other horizontal text lines may be calculated (such as 20 initial characters); for the horizontal text lines 601 and 603, a connecting line (hereinafter referred to as L2) connecting initial characters of the horizontal text lines 601 and 603 may be acquired, and the number of initial characters of L2 passing through other horizontal text lines may be calculated (such as 18 initial characters); and for the horizontal text lines 602 and 603, a connecting line (hereinafter referred to as L3) connecting initial characters of the horizontal text lines 602 and 603 may be acquired, and the number of initial characters of L3 passing through other horizontal text lines may be calculated (such as 12 initial characters), . . . and in a case where it is determined that 20 is the maximum number, L1 may be determined as the text line in the vertical direction.

Hence, multiple straight lines in the horizontal direction and vertical direction, as well as multiple text lines in the horizontal direction and vertical direction, may be obtained, thereby a set of the straight lines and the text lines may be formed.

The above description is given taking the whole document image as an example. In this embodiment, the document image may be segmented into one or more zones (such as to perform clustering by using connected components); and grouping may be performed based on multiple zones, then straight lines and/or text lines are extracted as per each group, thereby further improving accuracy of the extraction.

For example, the extracting multiple text lines based on a binary map of the document image may further include: respectively obtaining a top text line and a bottom text line in the horizontal direction of each zone, and a left text line and a right text line in the vertical direction of each zone.

Then, two zones of maximum areas of the document image may be selected (two zones are examples only, and this disclosure is not limited thereto), and the top text lines and the bottom text lines in the horizontal direction and the left text lines and the right text lines in the vertical direction of the two zones of maximum areas are taken as text lines to be used.

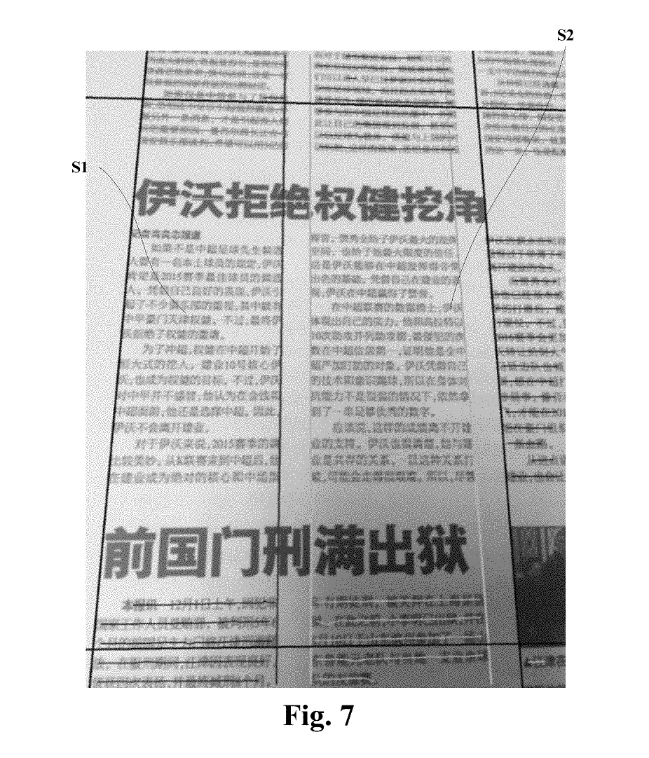

FIG. 7 is a schematic diagram of a document image including multiple zones of the embodiment of this disclosure. As shown in FIG. 7, the document image may be segmented into zones S1, and S2, etc., and straight line and/or text line extraction is respectively performed on these zones.

In block 205, the selecting two vertical lines and two horizontal lines from the extracted and classified straight lines and text lines may include: selecting the two vertical lines and two horizontal lines following a principle that an area of the rectangle formed by the two vertical lines and the two horizontal lines is maximal.

In this embodiment, two reliable horizontal lines and two reliable vertical lines may be selected to form the rectangle, the larger the rectangle the better, the horizontal lines may be in parallel with the text lines as possible, and vertical lines of a highest confidence may be selected. Hence, accuracy of the transformation matrix may further be improved.

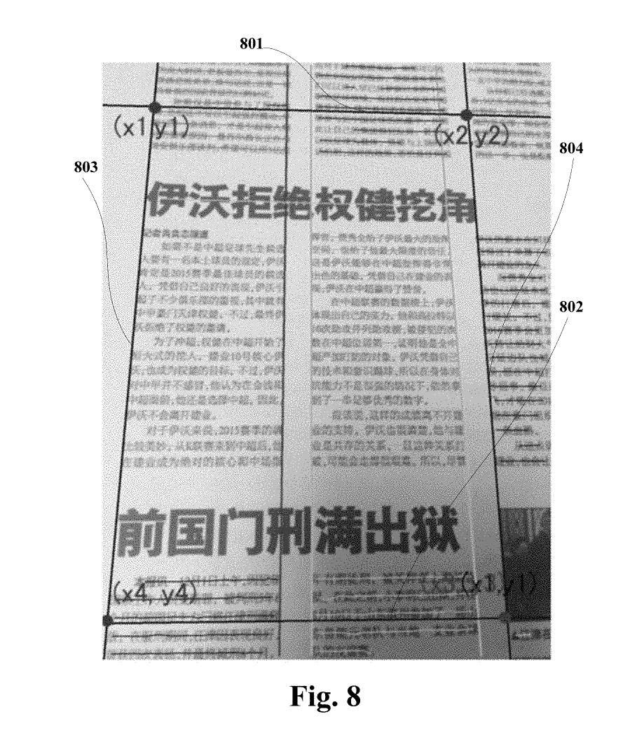

FIG. 8 is a schematic diagram of a source rectangle of the embodiment of this disclosure. As shown in FIG. 8, two horizontal lines 801 and 802 and two vertical lines 803 and 804 may be selected, so as to determine a source rectangle (such as in a rectangular shape) formed by these straight lines.

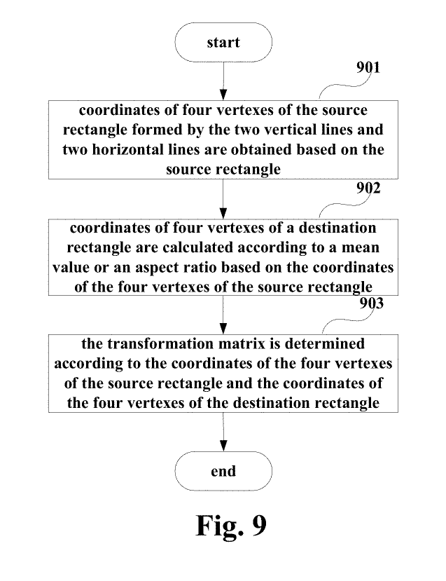

FIG. 9 is a schematic diagram of calculating the transformation matrix of the embodiment of this disclosure. As shown in FIG. 9, the calculating a transformation matrix based on a rectangle formed by the selected two vertical lines and two horizontal lines in block 206 may include:

Block 901: coordinates of four vertexes of the source rectangle formed by the two vertical lines and two horizontal lines are obtained based on the source rectangle;

Block 902: coordinates of four vertexes of a destination rectangle are calculated according to a mean value or an aspect ratio based on the coordinates of the four vertexes of the source rectangle; and

Block 903: the transformation matrix is determined according to the coordinates of the four vertexes of the source rectangle and the coordinates of the four vertexes of the destination rectangle.

For example, in the rectangle shown in FIG. 8, the four vertexes are (x1, y1) (x2, y2) (x3, y3) (x4, y4), respectively, and the coordinates of the four vertexes of the destination rectangle are calculated according to the mean value, that is,

x1′=(x1+x4)/2

y1′=(y1+y2)/2

x2′=(x2+x3)/2

y2′=y1′

x3′=x2′

y3′=(y3+y4)/2

x4′=x1′

y4′=y3′.

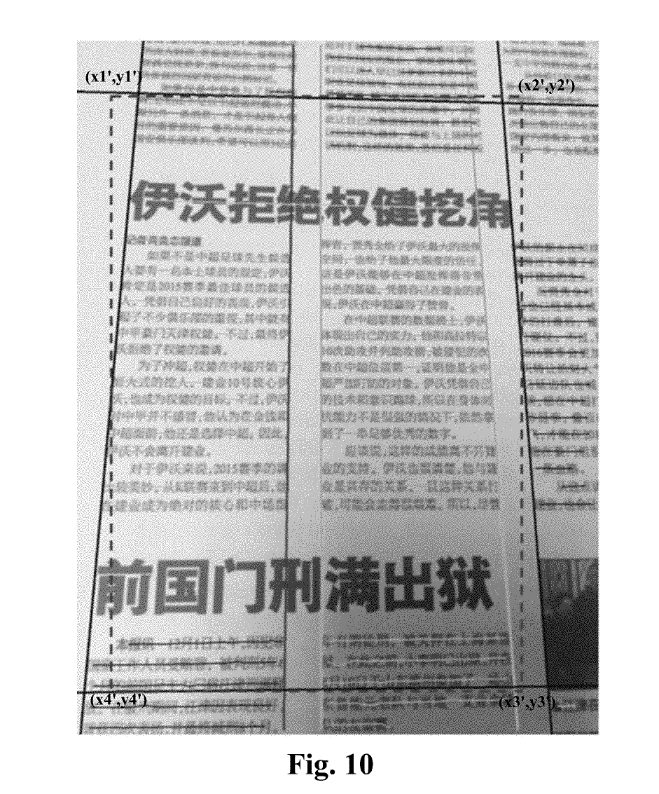

FIG. 10 is a schematic diagram of the destination rectangle of the embodiment of this disclosure. As shown in FIG. 10, according to the calculated four vertexes (x1′, y1′) (x2′, y2′) (x3′, y3′) (x4′, y4′) of the destination rectangle, the destination rectangle may be determined. Hence, the H matrix may be calculated according to the source rectangle and the destination rectangle, and the relevant art may be referred to for details of the H matrix.

It should be appreciated that how to calculate the coordinates of the four vertexes of the destination rectangle is only illustrated above taking the mean value as an example. However, this disclosure is not limited thereto; for example, the coordinates of the four vertexes of the destination rectangle may also be calculated by using a pre-obtained aspect ratio. The relevant art may be referred to for how to obtain the aspect ratio.

In block 207, the document image may be transformed by using the transformation matrix (the H matrix), so as to obtain a viewpoint transformed image. For example, for each pixel, a coordinate position of the pixel in a destination image may be determined by using the H matrix, and the coordinate position of the pixel in the destination image may be filled by using a pixel value of the pixel in the source image.

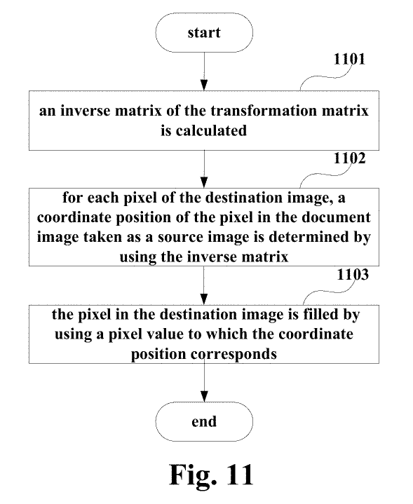

FIG. 11 is a schematic diagram of performing viewpoint transformation of the embodiment of this disclosure. As shown in FIG. 11, the transforming the document image by using the transformation matrix, so as to obtain a viewpoint transformed image, may further include:

Block 1101: an inverse matrix (an H′ matrix) of the transformation matrix (the H matrix) is calculated;

Block 1102: for each pixel of the destination image, a coordinate position of the pixel in the document image taken as a source image is determined by using the inverse matrix; and

Block 1103: the pixel in the destination image is filled by using a pixel value to which the coordinate position corresponds.

Hence, for each pixel of the destination image, a corresponding pixel value may be found, which may avoid a case where a pixel or some pixels are missed, so that display quality of the transformed document image is higher.

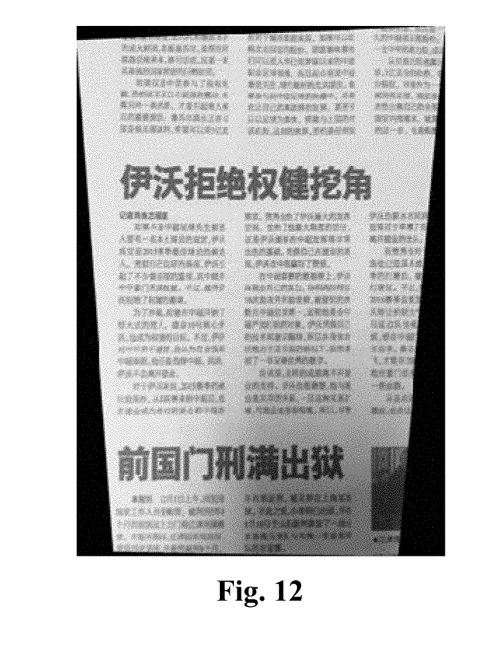

FIG. 12 is a schematic diagram of an example of the viewpoint transformed document image of the embodiment of this disclosure. As shown in FIG. 12, viewpoint transformation is accurately performed on the document image shown in FIG. 8, optical character recognition (OCR) is well improved in this disclosure, and in comparison with that partial document image can be corrected by an office lens, etc., boundaries of the document need not be within the capturing range. And even if the document is captured in enlarged manner, viewpoint transformation may still be performed by using the method of this disclosure.

It should be appreciated that the above accompanying drawings only illustrate the embodiment of this disclosure. However, this disclosure is not limited thereto; for example, an order of executing the blocks may be appropriately adjusted, and furthermore, some other blocks may be added, or some of the blocks may be omitted. And appropriate modifications may be performed by those skilled in the art according to the above contents, without being limited to the disclosure contained in the above accompanying drawings.

It can be seen from the above embodiment that multiple straight lines are extracted based on a gray scale map of a document image, and multiple text lines are extracted based on a binary map of the document image; two vertical lines and two horizontal lines are selected from the extracted and classified straight lines and text lines; and a transformation matrix is calculated based on a rectangle formed by the selected two vertical lines and two horizontal lines. Hence, even if a captured document image is incomplete, a perspective transformation matrix may be accurately obtained, thereby better performing image viewpoint transformation.

### Embodiment 2

The embodiment of this disclosure provides an image viewpoint transformation apparatus, with contents identical to those in Embodiment 1 being not going to be described herein any further.

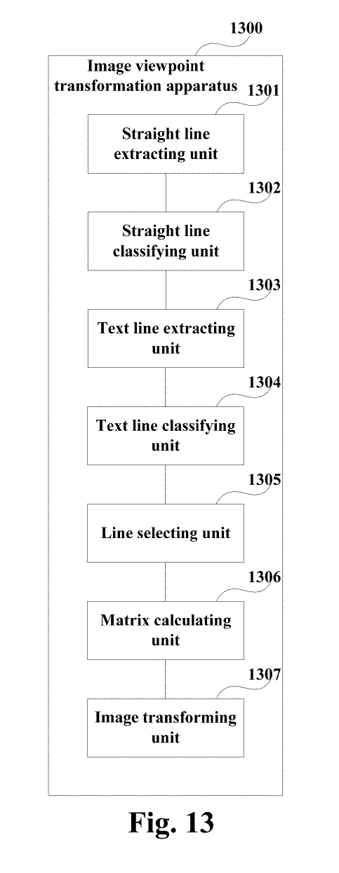

FIG. 13 is a schematic diagram of the image viewpoint transformation apparatus of the embodiment of this disclosure. As shown in FIG. 13, the image viewpoint transformation apparatus 1300 includes:

a straight line extracting unit 1301 configured to extract multiple straight lines based on a gray scale map of a document image;

a straight line classifying unit 1302 configured to perform classification for the multiple straight lines according to a horizontal direction and a vertical direction;

a text line extracting unit 1303 configured to extract multiple text lines based on a binary map of the document image;

a text line classifying unit 1304 configured to perform classification for the multiple text lines according to a horizontal direction and a vertical direction;

a line selecting unit 1305 configured to select two vertical lines and two horizontal lines from the extracted and classified straight lines and text lines;

a matrix calculating unit 1306 configured to calculate a transformation matrix based on a rectangle formed by the selected two vertical lines and two horizontal lines; and

an image transforming unit 1307 configured to transform the document image by using the transformation matrix, so as to obtain a viewpoint transformed image.

In this embodiment, two vertical lines and two horizontal lines may be selected from a set of the extracted straight lines and text lines, and then the transformation matrix is calculated based on the rectangle formed by the selected two vertical lines and two horizontal lines. Hence, even if a captured document image is incomplete, a perspective transformation matrix may be accurately obtained, thereby better performing image viewpoint transformation.

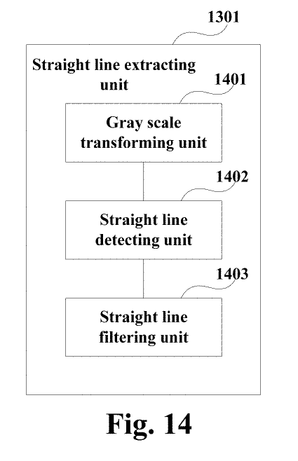

FIG. 14 is a schematic diagram of the straight line extracting unit 1301 of the embodiment of this disclosure. As shown in FIG. 14, the straight line extracting unit 1301 may include:

a gray scale transforming unit 1401 configured to transform the document image, so as to obtain the gray scale map;

a straight line detecting unit 1402 configured to detect straight lines in the gray scale map; and

a straight line filtering unit 1403 configured to filter straight lines of lengths less than a predefined threshold value in the detected straight lines.

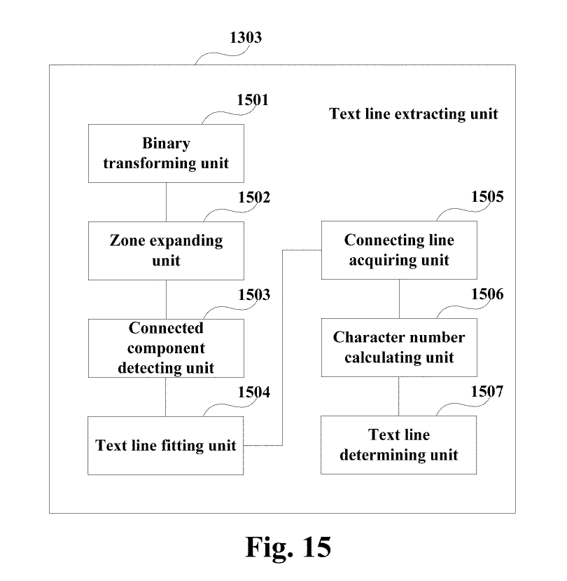

FIG. 15 is a schematic diagram of the text line extracting unit 1303 of the embodiment of this disclosure. As shown in FIG. 15, the text line extracting unit 1303 may include:

a binary transforming unit 1501 configured to transform the document image, so as to obtain the binary map;

a zone expanding unit 1502 configured to expand zones to which characters in the binary map correspond;

a connected component detecting unit 1503 configured to detect one or more connected components of the binary map; and

a text line fitting unit 1504 configured to fit the text lines in the horizontal direction based on the connected components.

As shown in FIG. 15, the text line extracting unit 1303 may further include:

a connecting line acquiring unit 1505 configured to, for any two text lines in the horizontal direction, acquire a connecting line connecting corresponding characters of the two text lines in the horizontal direction;

a character number calculating unit 1506 configured to calculate the number of corresponding characters of other text lines in the horizontal direction through which each of the connecting lines passes; and

a text line determining unit 1507 configured to determine a connecting line passing through a maximum number of corresponding characters of the other text lines in the horizontal direction as a text line in the vertical direction.

In an implementation, the document image may be segmented into one or more zones;

and the text line extracting unit 1303 may further be configured to respectively obtain a top text line and a bottom text line in the horizontal direction of each zone, and a left text line and a right text line in the vertical direction of each zone.

Furthermore, the text line extracting unit 1303 may further be configured to select two zones of maximum areas of the document image, and take the top text lines and the bottom text lines in the horizontal direction and the left text lines and the right text lines in the vertical direction of the two zones of maximum areas as text lines to be used.

In an implementation, the line selecting unit 1305 may particularly be configured to select the two vertical lines and two horizontal lines following a principle that an area of the rectangle formed by the two vertical lines and the two horizontal lines is maximal.

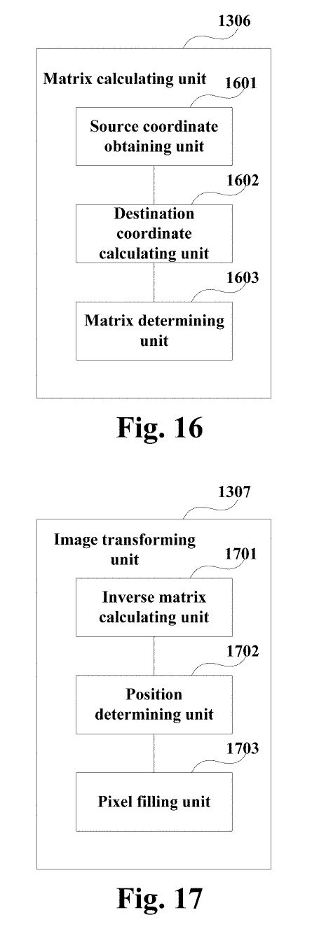

FIG. 16 is a schematic diagram of the matrix calculating unit 1306 of the embodiment of this disclosure. As shown in FIG. 16, the matrix calculating unit 1306 may include:

a source coordinate obtaining unit 1601 configured to obtain coordinates of four vertexes of a source rectangle formed by the two vertical lines and two horizontal lines based on the source rectangle;

a destination coordinate calculating unit 1602 configured to calculate coordinates of four vertexes of a destination rectangle according to a mean value or an aspect ratio based on the coordinates of the four vertexes of the source rectangle; and

a matrix determining unit 1603 configured to determine the transformation matrix according to the coordinates of the four vertexes of the source rectangle and the coordinates of the four vertexes of the destination rectangle.

FIG. 17 is a schematic diagram of the image transforming unit 1307 of the embodiment of this disclosure. As shown in FIG. 17, the image transforming unit 1307 may include:

an inverse matrix calculating unit 1701 configured to calculate an inverse matrix of the transformation matrix;

a position determining unit 1702 configured to, for each pixel of a destination image, determine a coordinate position of the pixel in the document image taken as a source image by using the inverse matrix; and

a pixel filling unit 1703 configured to fill the pixel in the destination image by using a pixel value to which the coordinate position corresponds.

It can be seen from the above embodiment that multiple straight lines are extracted based on a gray scale map of a document image, and multiple text lines are extracted based on a binary map of the document image; two vertical lines and two horizontal lines are selected from the extracted and classified straight lines and text lines; and a transformation matrix is calculated based on a rectangle formed by the selected two vertical lines and two horizontal lines. Hence, even if a captured document image is incomplete, a perspective transformation matrix may be accurately obtained, thereby better performing image viewpoint transformation.

### Embodiment 3

The embodiment of this disclosure provides electronic equipment, including the image viewpoint transformation apparatus 1300 described in Embodiment 2.

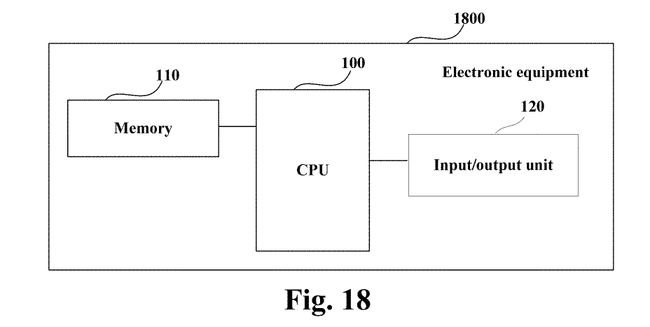

FIG. 18 is a schematic diagram of the electronic equipment of the embodiment of this disclosure, in which a structure of the electronic equipment is schematically shown. As shown in FIG. 18, the electronic equipment 1800 may include a central processing unit (CPU) 100 and a memory 110, the memory 110 being coupled to the central processing unit 100. The memory 110 may store various data, and furthermore, it may store a program for information processing, and execute the program under control of the central processing unit 100.

In an implementation, the functions of the image viewpoint transformation apparatus 1300 may be integrated into the central processing unit 100. The central processing unit 100 may be configured to carry out the image viewpoint transformation method described in Embodiment 1.

For example, the central processing unit 100 may be configured to carry out the following control: extracting multiple straight lines based on a gray scale map of a document image; classifying the multiple straight lines in a horizontal direction and a vertical direction; extracting multiple text lines based on a binary map of the document image; classifying the multiple text lines in a horizontal direction and a vertical direction; selecting two vertical lines and two horizontal lines from the extracted and classified straight lines and text lines; calculating a transformation matrix based on a rectangle formed by the selected two vertical lines and two horizontal lines; and transforming the document image by using the transformation matrix, so as to obtain a viewpoint transformed image.

In another implementation, the image viewpoint transformation apparatus 1300 and the central processing unit 100 may be configured separately. For example, the image viewpoint transformation apparatus 1300 may be configured as a chip connected to the central processing unit 100, with its functions being realized under control of the central processing unit 100.

As shown in FIG. 18, the electronic equipment 1800 may further include an input unit 120, etc. Functions of the above component are similar to those in the relevant art, and shall not be described herein any further. It should be appreciated that the electronic equipment 1800 does not necessarily include all the parts shown in FIG. 18, and furthermore, the electronic equipment 1800 may include parts not shown in FIG. 18, and the relevant art may be referred to.

An embodiment of the present disclosure provides a computer readable program code, which, when executed in electronic equipment, will cause an electronic equipment to carry out the image viewpoint transformation method as described in Embodiment 1 in the electronic equipment.

An embodiment of the present disclosure provides a non-transitory computer readable medium, including a computer readable program code, which will cause an electronic equipment to carry out the image viewpoint transformation method as described in Embodiment 1 in electronic equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of the present disclosure containing the above embodiments, following supplements are further disclosed.

Supplement 1. An image viewpoint transformation method, characterized in that the image viewpoint transformation method includes:

extracting multiple straight lines based on a gray scale map of a document image;

performing classification for the multiple straight lines according to a horizontal direction and a vertical direction;

extracting multiple text lines based on a binary map of the document image;

performing classification for the multiple text lines according to a horizontal direction and a vertical direction;

selecting two vertical lines and two horizontal lines from the extracted and classified straight lines and text lines;

calculating a transformation matrix based on a rectangle formed by the selected two vertical lines and two horizontal lines; and

transforming the document image by using the transformation matrix to obtain a viewpoint transformed image.

Supplement 2. The image viewpoint transformation method according to supplement 1, wherein the extracting multiple straight lines based on a gray scale map of a document image includes:

transforming the document image to obtain the gray scale map;

detecting straight lines in the gray scale map; and

filtering straight lines of lengths less than a predefined threshold value in the detected straight lines.

Supplement 3. The image viewpoint transformation method according to supplement 1, wherein the extracting multiple text lines based on a binary map of the document image includes:

transforming the document image to obtain the binary map;

expanding zones to which characters in the binary map correspond;

detecting one or more connected components of the binary map; and

fitting the text lines in the horizontal direction based on the connected components.

Supplement 4. The image viewpoint transformation method according to supplement 3, wherein the extracting multiple text lines based on a binary map of the document image further includes:

for any two text lines in the horizontal direction, acquiring a connecting line connecting corresponding characters of the two text lines in the horizontal direction;

calculating the number of corresponding characters of other text lines in the horizontal direction through which each of the connecting lines passes; and

determining a connecting line passing through a maximum number of corresponding characters of the other text lines in the horizontal direction as a text line in the vertical direction.

Supplement 5. The image viewpoint transformation method according to supplement 1, wherein the document image is segmented into one or more zones;

and the extracting multiple text lines based on a binary map of the document image includes: respectively obtaining a top text line and a bottom text line in the horizontal direction of each zone, and a left text line and a right text line in the vertical direction of each zone.

Supplement 6. The image viewpoint transformation method according to supplement 5, wherein the extracting multiple text lines based on a binary map of the document image further includes:

selecting two zones of maximum areas of the document image, and

taking the top text lines and the bottom text lines in the horizontal direction and the left text lines and the right text lines in the vertical direction of the two zones of maximum areas as text lines to be used.

Supplement 7. The image viewpoint transformation method according to supplement 1, wherein the selecting two vertical lines and two horizontal lines from the extracted and classified straight lines and text lines includes:

selecting the two vertical lines and two horizontal lines following a principle that an area of the rectangle formed by the two vertical lines and the two horizontal lines is maximal.

Supplement 8. The image viewpoint transformation method according to supplement 1, wherein the calculating a transformation matrix based on a rectangle formed by the selected two vertical lines and two horizontal lines includes:

obtaining coordinates of four vertexes of a source rectangle formed by the two vertical lines and two horizontal lines based on the source rectangle;

calculating coordinates of four vertexes of a destination rectangle according to a mean value or an aspect ratio based on the coordinates of the four vertexes of the source rectangle; and

determining the transformation matrix according to the coordinates of the four vertexes of the source rectangle and the coordinates of the four vertexes of the destination rectangle.

Supplement 9. The image viewpoint transformation method according to supplement 1, wherein the transforming the document image by using the transformation matrix to obtain a viewpoint transformed image, includes:

calculating an inverse matrix (an H′ matrix) of the transformation matrix (an H matrix);

for each pixel of a destination image, determining a coordinate position of the pixel in the document image taken as a source image by using the inverse matrix; and

filling the pixel in the destination image by using a pixel value to which the coordinate position corresponds.

Supplement 10. An image viewpoint transformation apparatus, characterized in that the image viewpoint transformation apparatus includes:

a straight line extracting unit configured to extract multiple straight lines based on a gray scale map of a document image;

a straight line classifying unit configured to perform classification for the multiple straight lines according to a horizontal direction and a vertical direction;

a text line extracting unit configured to extract multiple text lines based on a binary map of the document image;

a text line classifying unit configured to perform classification for the multiple text lines according to a horizontal direction and a vertical direction;

a line selecting unit configured to select two vertical lines and two horizontal lines from the extracted and classified straight lines and text lines;

a matrix calculating unit configured to calculate a transformation matrix based on a rectangle formed by the selected two vertical lines and two horizontal lines; and

an image transforming unit configured to transform the document image by using the transformation matrix to obtain a viewpoint transformed image.

Supplement 11. The image viewpoint transformation apparatus according to supplement 10, wherein the straight line extracting unit includes:

a gray scale transforming unit configured to transform the document image to obtain the gray scale map;

a straight line detecting unit configured to detect straight lines in the gray scale map; and

a straight line filtering unit configured to filter straight lines of lengths less than a predefined threshold value in the detected straight lines.

Supplement 12. The image viewpoint transformation apparatus according to supplement 10, wherein the text line extracting unit includes:

a binary transforming unit configured to transform the document image to obtain the binary map;

a zone expanding unit configured to expand zones to which characters in the binary map correspond;

a connected component detecting unit configured to detect one or more connected components of the binary map; and

a text line fitting unit configured to fit the text lines in the horizontal direction based on the connected components.

Supplement 13. The image viewpoint transformation apparatus according to supplement 12, wherein the text line extracting unit further includes:

a connecting line acquiring unit configured to, for any two text lines in the horizontal direction, acquire a connecting line connecting corresponding characters of the two text lines in the horizontal direction;

a character number calculating unit configured to calculate the number of corresponding characters of other text lines in the horizontal direction through which each of the connecting lines passes; and

a text line determining unit configured to determine a connecting line passing through a maximum number of corresponding characters of the other text lines in the horizontal direction as a text line in the vertical direction.

Supplement 14. The image viewpoint transformation apparatus according to supplement 10, wherein the document image is segmented into one or more zones;

and the text line extracting unit is further configured to respectively obtain a top text line and a bottom text line in the horizontal direction of each zone, and a left text line and a right text line in the vertical direction of each zone.

Supplement 15. The image viewpoint transformation apparatus according to supplement 14, wherein the text line extracting unit is further configured to select two zones of maximum areas of the document image, and take the top text lines and the bottom text lines in the horizontal direction and the left text lines and the right text lines in the vertical direction of the two zones of maximum areas as text lines to be used.

Supplement 16. The image viewpoint transformation apparatus according to supplement 10, wherein the line selecting unit is configured to select the two vertical lines and two horizontal lines following a principle that an area of the rectangle formed by the two vertical lines and the two horizontal lines is maximal.

Supplement 17. The image viewpoint transformation apparatus according to supplement 10, wherein the matrix calculating unit includes:

a source coordinate obtaining unit configured to obtain coordinates of four vertexes of a source rectangle formed by the two vertical lines and two horizontal lines based on the source rectangle;

a destination coordinate calculating unit configured to calculate coordinates of four vertexes of a destination rectangle according to a mean value or an aspect ratio based on the coordinates of the four vertexes of the source rectangle; and

a matrix determining unit configured to determine the transformation matrix according to the coordinates of the four vertexes of the source rectangle and the coordinates of the four vertexes of the destination rectangle.

Supplement 18. The image viewpoint transformation apparatus according to supplement 10, wherein the image transforming unit includes:

an inverse matrix calculating unit configured to calculate an inverse matrix (an H′ matrix) of the transformation matrix (an H matrix);

a position determining unit configured to, for each pixel of a destination image, determine a coordinate position of the pixel in the document image taken as a source image by using the inverse matrix; and

a pixel filling unit configured to fill the pixel in the destination image by using a pixel value to which the coordinate position corresponds.

Supplement 19. An electronic equipment, configured with the image viewpoint transformation apparatus as described in supplement 10.

What is claimed is:

1. An image viewpoint transformation apparatus, the image viewpoint transformation apparatus comprises:
a processor, comprising:
a straight line extracting unit configured to extract multiple straight lines based on a gray scale map of a document image;
a straight line classifying unit configured to perform classification for the multiple straight lines according to a horizontal direction and a vertical direction;
a text line extracting unit configured to extract multiple text lines based on a binary map of the document image;
a text line classifying unit configured to perform classification for the multiple text lines according to the horizontal direction and the vertical direction;
a line selecting unit configured to select two vertical lines and two horizontal lines from extracted and classified straight lines and text lines;
a matrix calculating unit configured to calculate a transformation matrix based on a rectangle formed by the two vertical lines and two horizontal lines selected; and
an image transforming unit configured to transform the document image by using the transformation matrix to obtain a viewpoint transformed image.

2. The image viewpoint transformation apparatus according to claim 1, wherein the straight line extracting unit comprises:
a gray scale transforming unit configured to transform the document image to obtain the gray scale map;
a straight line detecting unit configured to detect straight lines in the gray scale map; and
a straight line filtering unit configured to filter straight lines of lengths less than a predefined threshold value in detected straight lines.

3. The image viewpoint transformation apparatus according to claim 1, wherein the text line extracting unit comprises:
a binary transforming unit configured to transform the document image to obtain the binary map;
a zone expanding unit configured to expand zones to which characters in the binary map correspond;
a connected component detecting unit configured to detect one or more connected components of the binary map; and
a text line fitting unit configured to fit the text lines in the horizontal direction based on the connected components.

4. The image viewpoint transformation apparatus according to claim 3, wherein the text line extracting unit further comprises:
a connecting line acquiring unit configured to, for any two text lines in the horizontal direction, acquire a connecting line connecting corresponding characters of the two text lines in the horizontal direction;
a character number calculating unit configured to calculate a number of corresponding characters of other text lines in the horizontal direction through which each connecting line passes; and
a text line determining unit configured to determine the connecting line passing through a maximum number of corresponding characters of the other text lines in the horizontal direction as the text line in the vertical direction.

5. The image viewpoint transformation apparatus according to claim 1, wherein the document image is segmented into one or more zones;
and the text line extracting unit is further configured to respectively obtain a top text line and a bottom text line in the horizontal direction of each zone, and a left text line and a right text line in the vertical direction of each zone.

6. The image viewpoint transformation apparatus according to claim 5, wherein the text line extracting unit is further configured to select two zones of maximum areas of the document image, and take top text lines and bottom text lines in the horizontal direction and left text lines and right text lines in the vertical direction of the two zones of maximum areas as text lines.

7. The image viewpoint transformation apparatus according to claim 1, wherein the line selecting unit is configured to select the two vertical lines and two horizontal lines based on an area of the rectangle formed by the two vertical lines and the two horizontal lines being maximal.

8. The image viewpoint transformation apparatus according to claim 1, wherein the matrix calculating unit comprises:
a source coordinate obtaining unit configured to obtain coordinates of four source vertexes of a source rectangle formed by the two vertical lines and two horizontal lines based on the source rectangle;
a destination coordinate calculating unit configured to calculate coordinates of four destination vertexes of a destination rectangle according to one of a mean value and an aspect ratio based on the coordinates of the four source vertexes of the source rectangle; and
a matrix determining unit configured to determine the transformation matrix according to the coordinates of the four source vertexes of the source rectangle and the coordinates of the four destination vertexes of the destination rectangle.

9. The image viewpoint transformation apparatus according to claim 1, wherein the image transforming unit comprises:
an inverse matrix calculating unit configured to calculate an inverse matrix of the transformation matrix;
a position determining unit configured to, for each pixel of a destination image, determine a coordinate position of a pixel in the document image used as a source image by using the inverse matrix; and
a pixel filling unit configured to fill the pixel in the destination image by using a pixel value to which the coordinate position corresponds.

10. An image viewpoint transformation method the image viewpoint transformation method comprising:
extracting multiple straight lines based on a gray scale map of a document image;
performing classification for the multiple straight lines according to a horizontal direction and a vertical direction;
extracting multiple text lines based on a binary map of the document image;
performing classification for the multiple text lines according to the horizontal direction and the vertical direction;
selecting two vertical lines and two horizontal lines from extracted and classified straight lines and text lines;
calculating a transformation matrix based on a rectangle formed by the two vertical lines and two horizontal lines selected; and
transforming the document image by using the transformation matrix to obtain a viewpoint transformed image.

11. A non-transitory computer readable storage media storing a method according to claim 10.

12. An image viewpoint transformation apparatus, the image viewpoint transformation apparatus comprises:
a straight line extractor to extract multiple straight lines based on a gray scale map of a document image;
a straight line classifier to perform classification for the multiple straight lines according to a horizontal direction and a vertical direction;
a text line extractor to extract multiple text lines based on a binary map of the document image;
a text line classifier to perform classification for the multiple text lines according to the horizontal direction and the vertical direction;
a line selector to select two vertical lines and two horizontal lines from extracted and classified straight lines and text lines;
a matrix calculator to calculate a transformation matrix based on a rectangle formed by the two vertical lines and two horizontal lines selected; and
an image transformer to transform the document image by using the transformation matrix to obtain a viewpoint transformed image.
